(19) United States
(12) Patent Application Publication
(10) Pub. No.: US 2017/0271033 A1
(43) Pub. Date: Sep. 21, 2017

(54) FROTH SEPARATION IN A MOLTEN SALT REACTOR

(71) Applicant: Elysium Industries Limited, Vancouver (CA)

(72) Inventors: Andrew McCall Dodson, Malden, MA (US); William Wangard, Boston, MA (US)

(21) Appl. No.: 15/342,509

(22) Filed: Nov. 3, 2016

Related U.S. Application Data
(60) Provisional application No. 62/251,410, filed on Nov. 5, 2015.

(51) Int. Cl. G21C 19/31; B01D 19/00; B01F 3/22; B01F 3/04

(52) U.S. Cl. CPC G21C 19/31; B01F 3/04446; B01D 19/0031; B01F 3/2261; B01F 2003/04964; B01F 2215/0095

(57) ABSTRACT

A molten salt reactor includes a reactor vessel and a molten salt contained within the reactor vessel and undergoing a nuclear reaction. The molten salt includes insoluble metal fission products and dissolved gas fission products produced by the nuclear reaction. There is a separation unit configured to receive the molten salt and remove the insoluble metal fission products and dissolved gas fission products from the molten salt. The separation unit includes a laundering chamber into which the molten salt is introduced to form a froth containing the insoluble metal fission products and dissolved gas fission products. There is a filtration chamber, interconnected to the laundering chamber, configured to receive the froth from the laundering chamber and separate from the froth the insoluble metal fission products and dissolved gas fission products.

### FIELD OF INVENTION

The present invention relates generally to molten salt nuclear reactors and more specifically to removing fission products using froth separation in a molten salt reactor.

### BACKGROUND

To improve on previous Light Water Reactor (LWR) technologies, Molten Salt Reactors (MSRs) have been researched since the 1950s. MSRs are a class of nuclear fission reactors in which the primary coolant, or even the fuel itself, is a molten salt mixture (e.g., fluoride or chloride salt). Compared to LWRs, MSRs offer projected lower per-kilowatt hour (kWh) levelized cost, comparatively benign fuel and waste inventory composition, highly efficient fuel utilization, and a combination of higher accident resistance with lower worst-case accident severity (due to more benign inventory composition). In various designs, the innate physical properties of MSRs passively and indefinitely remove decay heat and bind fission products.

Early development of MSRs was primarily from the 1950s to 1970s, but a renewed interest in MSRs has recently been developed. However, since less development effort has been devoted to MSRs than to other reactor types, various technical challenges remain to be solved in order to develop a commercially viable system.

One technical challenge to MSR reactor technology is the accumulation of fission products generated during the nuclear fission in the molten salt. Typical fission products include 1) gas fission products (e.g., noble gases such as Xe and Kr); 2) insoluble fission products (e.g., noble metals such as Nb, Mo, Ru, Sb and Te); and 3) soluble fission products (e.g., Sr, Y, Zr, I, Cs, Ba and Ce).

Accumulation of gas fission products may decrease the fissionability of the molten salt. For example, ¹³⁵Xe carries a relatively high thermal neutron cross section (i.e., likelihood of interaction between a ¹³⁵Xe nucleus and incident neutron). By absorbing neutrons, ¹³⁵Xe tends to decrease the fissionability of the fuel mix (“poisoning”). The insoluble fission products including noble metals are incompatible with the molten salt and migrate to various surfaces in the reactor system and adhere to them. Such surfaces include piping, pumps, and heat-exchanger surfaces. The accumulation of these insoluble fission products on metal surfaces can produce significant radioactive decay heat that may lead to a loss of cooling and damage to the molten salt reactor. It is therefore desired to remove at least a portion of the insoluble fission products and gas fission products during the nuclear fission.

Researchers have demonstrated that a filter can be placed in the flow of the circulating molten salt to remove noble metals (R. J. Kedl, “The Migration of a Class of Fission Products (Noble Metals) in the Molten-Salt Reactor Experiment,” ORNL-TM-3884, Oak Ridge National Laboratory, December 1972). However, such design requires system stoppage for servicing and a more powerful and/or a larger pump to compensate for driving the flow of molten salt through the filter. Moreover, such an approach does not remove the gas fission products from the molten salt.

To release the gas fission products from the molten salt, spraying of molten salt has been tested (J. R. Engel, P. N. Haubenreich, and A. Houtzeel, “Spray, Mist, Bubbles and Foam in the Molten Salt Reactor Experiment,” ONRL-TM-3027, Oak Ridge National Laboratory, June, 1970). However, mist from the spray process was found to clog the off-gas lines, and this approach may introduce gas bubbles into the circulating molten salt and results in the migration of the gas bubbles to other parts of the reactor.

One prior art solution is shown in FIG. 1. To include a centrifugal pump in which removal of noble metals and/or noble gasses from circulating molten fuel salt may be achieved. The pump is employed to circulate molten salt from a molten salt reactor to a primary heat exchanger. In a typical state of operation, the molten salt enters the intake, ascends into a rotating impeller, passes into a volute, and is expelled through a discharge port. A portion of the pressurized salt is directed to a toroidal spray-head that sprays the salt into a pump casing (bowl). The pump bowl contains a volume of molten salt (indicated by broken horizontal lines) and a gas-filled volume. Noble gases migrate from droplets of fuel salt sprayed from the toroidal spray head to the gas-filled volume. The gas filling the volume typically includes a majority of “clean” (nonradioactive), non-reactive gas (e.g., helium) with an admixture of other substances, e.g., noble gases derived from fission in the molten salt.

A flow of clean gas is admitted to the pump bowl through a reference line and an equal flow of helium enriched with noble gases derived from the sprayed salt. The pump also contains provisions for bubbling or sparging clean gas through the liquid salt in the pump bowl. The spray-head and gas-flow provisions of the pump therefore act as a filter or purifier to remove noble gases from the molten fuel salt as it is circulated through the reactor system. Moreover, a filter comprising a web, sponge, mesh, or foam of nickel, steel, carbon, or other heat-resistant substance can be positioned in the liquid-filled portion of the pump bowl so that salt circulates through the filter and deposits particles of noble metals therein. For example, a toroidal filter could be placed around the secondary volute intake, which admits liquid salt from the pump bowl to the main flow of salt entering the impeller: all salt circulated through pump bowl would pass through such a filter. Such prior art system, however, has disadvantages, including clogging of the off-gas line by freezing salt mist and entrainment of gas into the salt discharged by the pump.

### SUMMARY

It is therefore an object of the invention to provide an effective, efficient, and economical solution to removing insoluble fission products and gas fission products from the molten salt.

In one aspect of the present invention a molten salt reactor is disclosed which includes a reactor vessel and a molten salt contained within the reactor vessel and undergoing a nuclear reaction. The molten salt includes insoluble metal fission products and dissolved gas fission products produced by the nuclear reaction. There is a separation unit configured to receive the molten salt and remove the insoluble metal fission products and dissolved gas fission products from the molten salt. The separation unit includes a laundering chamber into which the molten salt is introduced to form a froth containing the insoluble metal fission products and dissolved gas fission products. There is a filtration chamber, interconnected to the laundering chamber, configured to receive the froth from the laundering chamber and separate from the froth the insoluble metal fission products and dissolved gas fission products.

In other aspects of the invention one or more of the following features may be included. The laundering chamber may include a mixer to mix the molten salt received from the reactor vessel with a gas and a nozzle to spray the molten salt and gas mixture into a liquid salt contained within the laundering chamber to form the froth on the surface of the liquid salt. The filtration chamber may include a filter into which the froth from the laundering chamber is received and the output of which is a molten salt filtrate; the filter collecting the insoluble metal fission products and causing the release of the dissolved gas fission products. The filtration chamber may include a first portion proximate a first end of the filter for collecting the dissolved gas fission products and a second portion proximate a second end of the filter for collecting the molten salt filtrate. The filter may be a mesh filter comprising one of stainless steel or nickel. The mesh size of the filter may decrease from the first end of the filter to the second end of the filter.

In yet other aspects of the invention one or more of the following features may be included. There may further be included a gas holdup vessel interconnected to the first portion of the filtration chamber to collect the dissolved gas fission products from the filtration chamber; wherein the dissolved gas fission products collected in the gas holdup vessel are provided to the laundering chamber to be combined with the molten salt and gas mixture in the laundering chamber. There may also be a return pipe interconnected between the second portion of the filtration chamber and the reactor vessel to return the molten salt filtrate to the reactor vessel. There may further be included a pump to pressurize the molten salt received from the reactor vessel before being introduced to the mixer. The laundering chamber may include a down-comer, having a first end wherein the nozzle is positioned above the surface of the liquid salt contained within the laundering chamber, and a second end with an opening located beneath the surface of the liquid; the molten salt and gas mixture impinging on the surface of the liquid salt in the down-comer thereby producing the froth within the down-comer, the froth exiting the second opening of the down-comer rising to the surface of the liquid salt. The laundering chamber may include a liquid salt and a device to introduce the molten salt received from the reactor vessel to the liquid salt, the laundering chamber also includes a gas input device to introduce a pressurized gas into the liquid salt proximate a bottom of the laundering chamber, the pressurized gas traveling to a surface of the liquid salt thereby forming the froth on the surface of the liquid salt.

In another one aspect of the present invention a separation unit is disclosed. The separation unit is configured to receive molten salt from a reactor vessel, the molten salt including insoluble metal fission products and dissolved gas fission products. The separation unit includes a laundering chamber into which the molten salt is introduced to form a froth containing the insoluble metal fission products and dissolved gas fission products. There is a filtration chamber, interconnected to the laundering chamber, configured to receive the froth from the laundering chamber and separate from the froth the insoluble metal fission products and dissolved gas fission products.

In a further aspect of the present invention a method for removing fission products from molten salt in a molten salt nuclear reactor is disclosed. The method includes introducing to a laundering chamber molten salt received from the molten salt nuclear reactor, the molten salt including insoluble metal fission products and dissolved gas fission products. The method also includes forming a froth containing the insoluble metal fission products and dissolved gas fission products in the laundering chamber and transferring the froth from the laundering chamber to a filtration chamber. In the filtration chamber the method includes separating from the froth the insoluble metal fission products and dissolved gas fission products.

In other aspects of the invention one or more of the following features may be included. The method may include mixing the molten salt received from the reactor vessel with a gas and spraying the molten salt and gas mixture into a liquid salt contained within the laundering chamber to form the froth on the surface of the liquid salt. It may also include filtering the froth to produce a molten salt filtrate and to cause the release of the dissolved gas fission products. The filtration chamber may include a first portion proximate a first end of the filtration chamber for collecting the dissolved gas fission products and a second portion proximate a second end of the filtration chamber for collecting the molten salt filtrate. The step of filtering may include using a mesh filter comprising one of stainless steel or nickel. The mesh size of the filter decreases from a first end of the filter to a second end of the filter.

In other aspects of the invention one or more of the following features may be included. The method may further include collecting in a holdup vessel the dissolved gas fission products from the first end of the filtration chamber and combining the collected dissolved gas fission products with the molten salt and gas mixture in the laundering chamber. The method may also include returning the molten salt filtrate to the reactor vessel and it may include pressurizing the molten salt received from the reactor vessel before the step of introducing the molten salt to the laundering chamber. The method may further includer providing in the laundering chamber a down-comer, having a first end above the surface of the liquid salt contained within the laundering chamber, and a second end with an opening located beneath the surface of the liquid. The method may include impinging the molten salt and gas mixture on the surface of the liquid salt in the down-comer thereby producing the froth within the down-comer; the froth exiting the second opening of the down-comer and rising to the surface of the liquid salt. The method may additionally include introducing the molten salt received from the reactor vessel to a liquid salt in the laundering chamber and introducing a pressurized gas into the liquid salt proximate a bottom of the laundering chamber; wherein the pressurized gas travels to a surface of the liquid salt thereby forming the froth on a surface of the liquid salt.

### DESCRIPTION OF DRAWINGS

FIG. 1 is a cross-sectional view of a prior art centrifugal pump for a molten salt nuclear reactor.

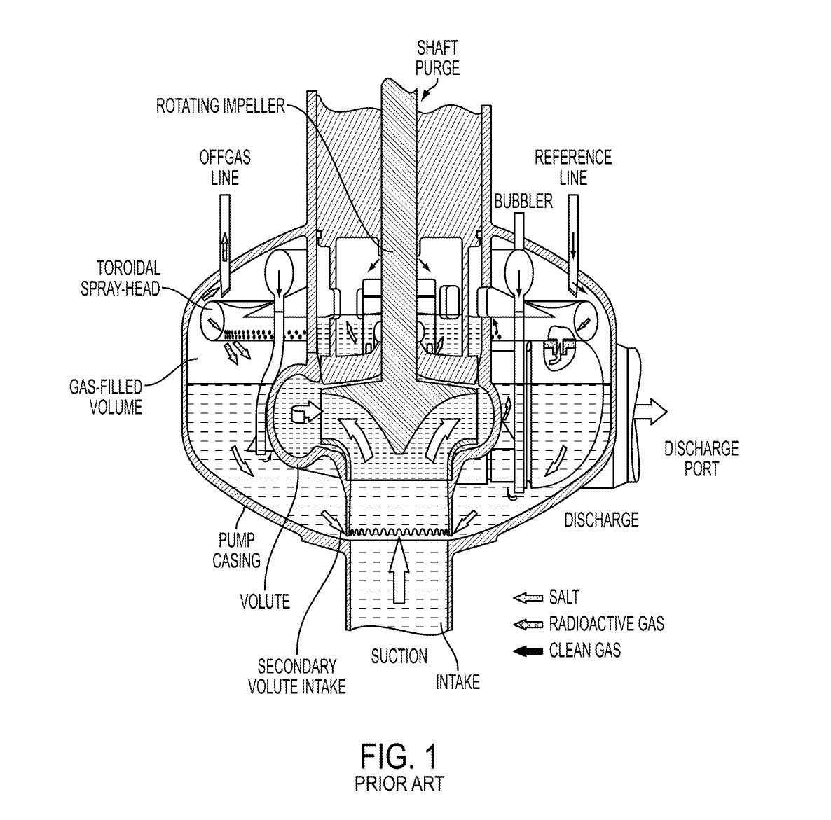

FIG. 2 is a schematic diagram depicting a molten salt reactor system.

FIG. 3 is a schematic diagram depicting the chemical processing plant of the molten salt reactor system depicted in FIG. 2.

FIG. 4 is a flow diagram depicting the operation of a froth floatation separation unit according to this invention.

FIG. 5 is a cross-sectional view of a froth floatation separation unit according to an embodiment of this invention.

FIG. 6 is a cross-sectional view of a froth floatation separation unit according to another embodiment of this invention.

### DETAILED DESCRIPTION

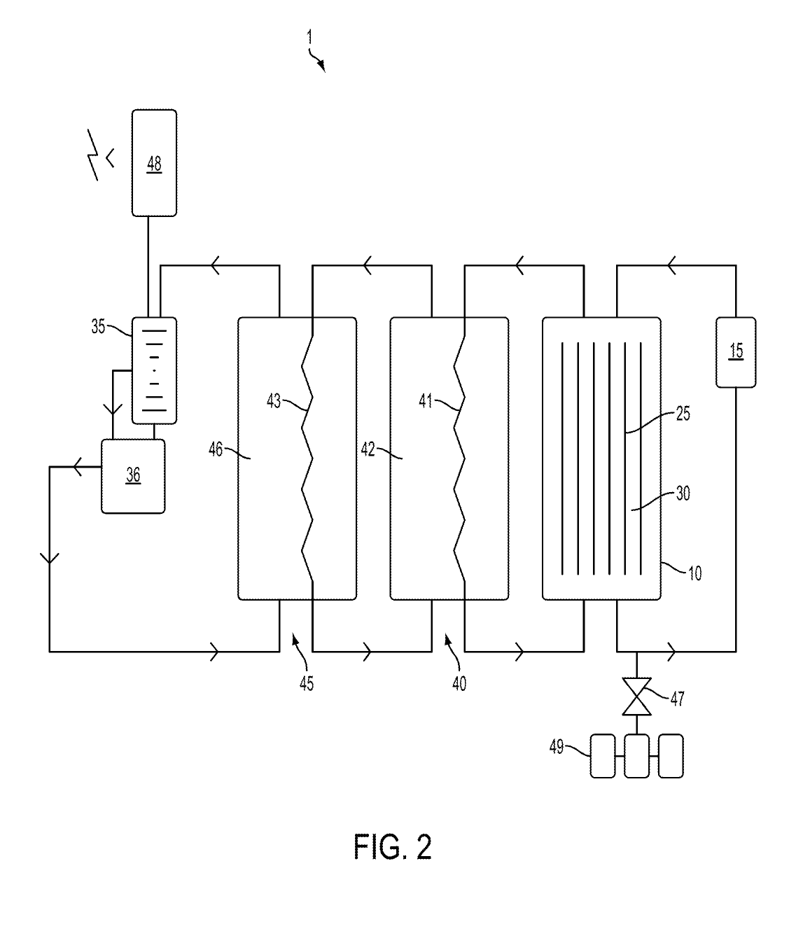

In a preferred embodiment, a molten salt reactor system 1 for the generation of electrical energy from nuclear fission is depicted in FIG. 2. System 1 includes a molten salt reactor 10, containing molten salt 30 which may include a mixture of chloride and fluoride salts. The mixture may comprise fissile materials, including thorium (Th), protactinium (Pa), uranium (U), neptunium (Np), Plutonium (Pu), Americium (Am), Curium (Cm) (more specifically Th-225, Th-227, Th-229, Pa-228, Pa-230, Pa-232, U-231, U-233, U-235, Np-234, Np-236, Np-238, Pu-237, Pu-239, Pu-241, Am-240, Am-242, Am-244, Cm-243, Cm-245, Cm-247), and fertile materials, such as Th₂₃₂Cl₄, U₂₃₈Cl₃ and U₂₃₈Cl₄. In this embodiment, the mixture comprises fissile materials including UCl₃, UCl₄and ThCl₄, and carrier salts including sodium chloride (NaCl), potassium chloride (KCl), and/or calcium chloride (CaCl₂).

Upon absorbing neutrons, nuclear fission may be initiated and sustained in the fissile molten salt 30, generating heat that elevates the temperature of the molten salt 30 to, e.g. approximately 650° C.≈1,200° F. The heated molten salt 30 is transported via a pump (not shown) from the molten salt reactor 10 to a heat exchange unit 40, which is configured to transfer the heat generated by the nuclear fission from the molten salt 30.

The transfer of heat from salt 30 may be realized in various ways. For example, the heat exchange unit 40 may include a pipe 41, through which the heated molten salt 30 travels, and a secondary fluid 42 (e.g., a coolant salt) that surrounds the pipe and absorbs heat from the molten salt 30. Upon heat transfer, the temperature of the molten salt 30 is reduced in the heat exchange unit 40, and the molten salt 30 is transported from the heat exchange unit 40 back to the molten salt reactor 10. A secondary heat exchange unit 45 may be included to transfer heat from the secondary fluid 42 to a tertiary fluid 46 (e.g., water), as fluid 42 is circulated through secondary heat exchange unit 45 via pipe 43.

The heat received from the molten salt 30 may be used to generate power (e.g., electric power) using any suitable technology. For example, the water in the secondary heat exchange unit 45 is heated to a steam and transported to a turbine 35. The turbine 35 is turned by the steam and drives an electrical generator 48 to produce electricity. Steam from the turbine 35 is conditioned by an ancillary gear 36 (e.g., a compressor, a heat sink, a pre-cooler or a recuperator) and transported back to the secondary heat exchange unit 45.

Alternatively, the heat received from the molten salt 30 may be used in other applications such as nuclear propulsion (e.g., marine propulsion), desalination, domestic or industrial heating, hydrogen production, or a combination thereof.

During the operation of the molten salt reactor 10, fission products will be generated in the molten salt 30. The fission products will include a range of elements. In this preferred embodiment, the fission products may include, but are not limited to, rubidium (Rb), strontium (Sr), cesium (Cs), barium (Ba), an element selected from lanthanides, palladium (Pd), ruthenium (Ru), silver (Ag), molybdenum (Mo), niobium (Nb), antimony (Sb), technetium (Tc), Xenon (Xe) or Krypton (Kr).

The buildup of fission products (e.g., radioactive noble metals and radioactive noble gases) in molten salt 30 may impede or interfere with the nuclear fission in the molten salt reactor 10 by poisoning the nuclear fission. For example, xenon-135 and samarium-149 have a high neutron absorption capacity, and may lower the reactivity of the molten salt. Fission products may also reduce the useful lifetime of the molten salt reactor 10 by clogging components, such as heat exchangers or piping.

Therefore, it is generally necessary to keep concentrations of fission products in the molten salt 30 below certain thresholds to maintain proper functioning of the reactor 10. This may be accomplished by a chemical processing plant 15 configured to remove at least a portion of fission products generated in the molten fuel salt 30 during nuclear fission. During operation, molten salt 30 is transported from the molten salt reactor 10 to the chemical processing plant 15, which may processes the molten salt 30 so that the molten salt reactor 10 functions without loss of efficiency or degradation of components. An actively cooled freeze plug 47 is included and configured to allow the molten salt 30 to flow into a set of emergency dump tanks 49 in case of power failure or on active command.

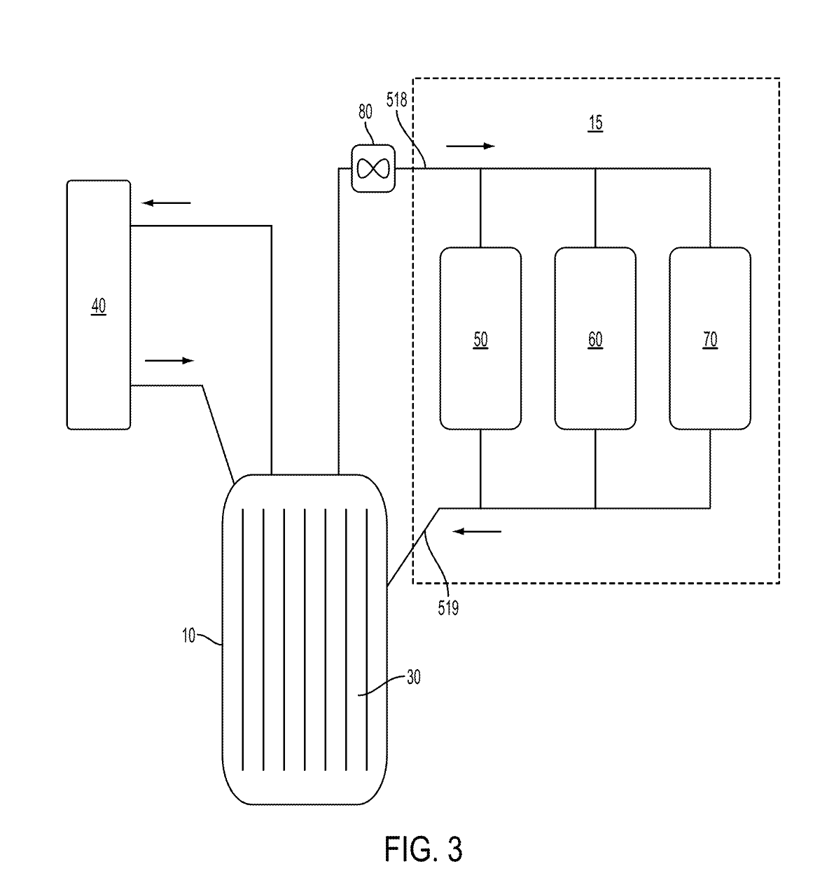

FIG. 3 shows additional detail of the chemical processing plant 15. The molten salt 30 is circulated continuously (or near-continuously) by way of pump 80 from the molten salt reactor 10 through the chemical processing plant 15. In addition to removing fission products, the chemical processing plant 15 is also configured to limit or reduce the corrosion of the molten salt reactor 10 by the molten salt 30 by way of a corrosion reduction unit 50, FIG. 3.

The chemical processing plant 30 also includes a separation unit or froth floatation unit (the terms may be used interchangeably herein) 60 configured to remove at least part of the insoluble fission products, e.g., krypton (Kr), Xenon (Xe), palladium (Pd), ruthenium (Ru), silver (Ag), molybdenum (Mo), niobium (Nb), antimony (Sb), technetium (Tc), from molten salt 30. Froth floatation unit 60 is also configured to remove at least part of the dissolved gas fission products (e.g., Xenon (Xe) or Krypton (Kr)). The froth floatation unit 60 generates froth from the molten salt 30 that includes insoluble fission products and dissolved gas fission products. The dissolved gas fission products are removed from the froth, and at least a portion of the insoluble fission products are removed by filtration.

Also included in chemical processing plant 15 is salt exchange unit 70 which is configured to remove at least a portion of the fission products (e.g., rubidium (Rb), strontium (Sr), cesium (Cs), barium (Ba) or an element selected from lanthanides) soluble in the molten salt 30. The removal of soluble fission products may be realized through various mechanisms.

During the nuclear fission, the molten salt 30 is transported from the reactor 10 to the froth floatation unit 60 and from froth floatation unit 60 back to the reactor 10. The transportation may be driven by a pump 80 and the pump 80 may be configured to adjust the flow rate of the molten salt 30.

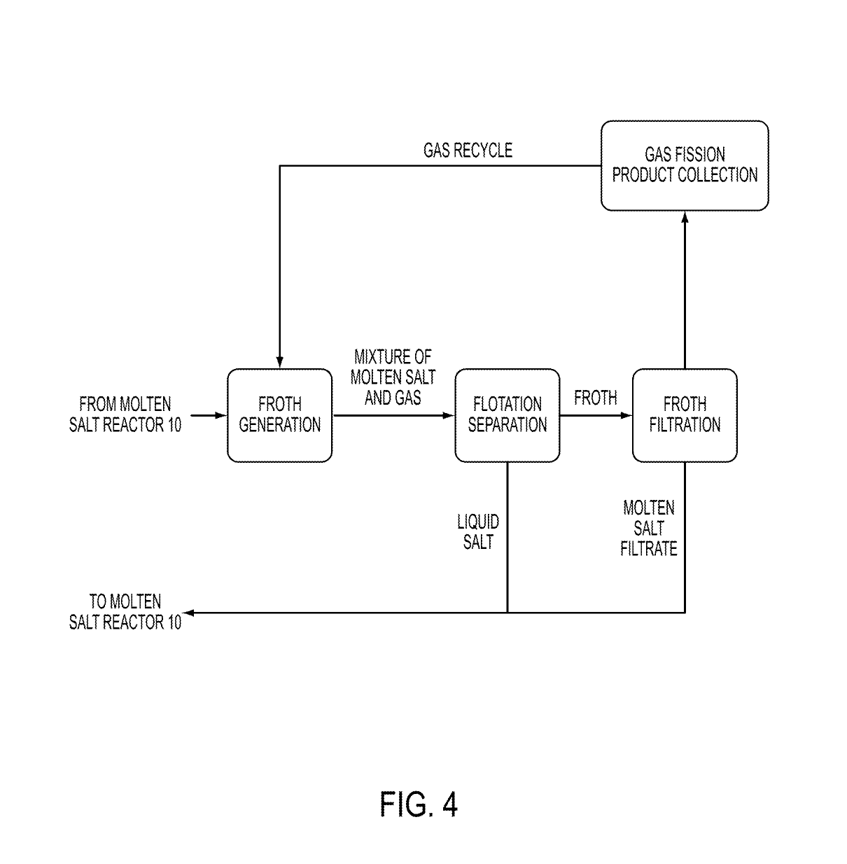

FIG. 4 is a flow diagram depicting the operation of the froth flotation unit 60 according to the invention. Upon entering the froth floatation unit 60, molten salt 30 from the molten salt reactor 10 is mixed with a gas (including a significant fraction of one or more inert gasses, e.g., helium or argon) to generate a froth in a liquid salt. The liquid salt may be the molten salt 30. The froth is then separated from the liquid salt through a flotation separation unit, and at least a portion of the liquid salt may be returned to the molten salt reactor 10.

One or more insoluble fission products are then removed from the froth through a filtration. Upon filtration, molten salt filtrate with at insoluble fission products removed is received. The molten salt filtrate is the returned to the molten salt reactor 10.

During the filtration, the froth breaks down and releases one or more gas fission products. The released gas fission products are collected (e.g. by a suitable adsorbent such as carbon). The collected gas fission products may be recycled to mix with the molten salt 30 during the froth generation. The recycle may allow radioactive gases to further decay in the froth floatation unit 60, and to generate decay product that are collected and removed from the froth floatation unit 60.

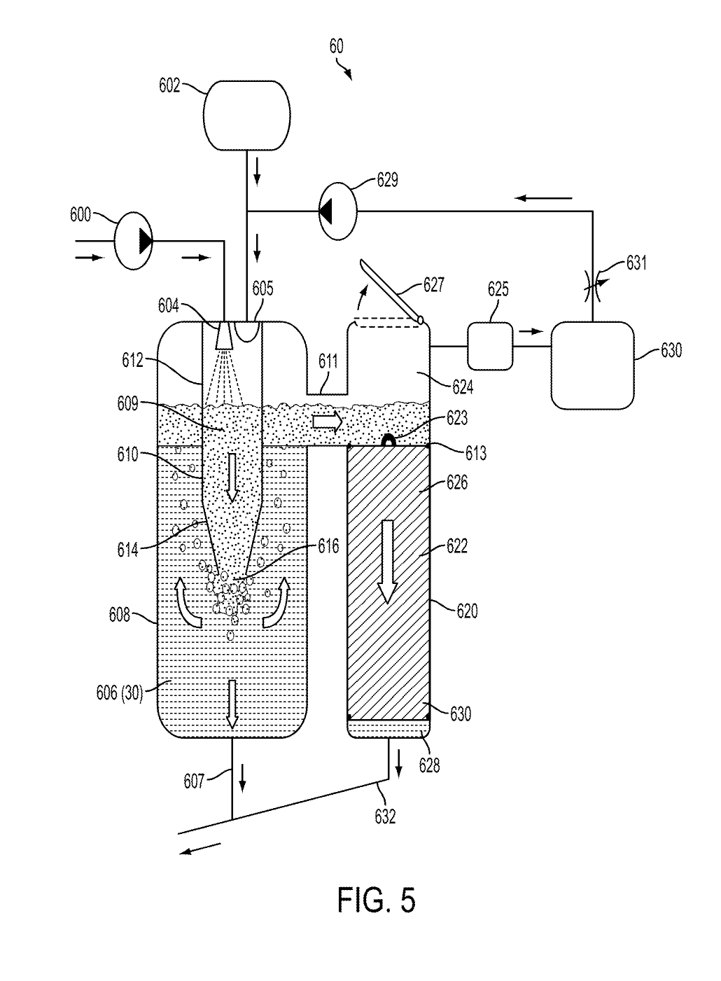

FIG. 5 illustrates an embodiment of the froth floatation unit 60. Upon entering unit 60, the molten salt 30, having one or more insoluble fission products and one or more dissolved gas fission products, is pressurized by a pump 600. The pressurized molten salt 30 is sprayed by a nozzle 604, and mixed with a gas injected by a gas input 605 (e.g., argon, helium, or a mixture of these and/or other gases), wherein at least a portion of the gas is supported from a gas source 602. The nozzle 604 may include a demisting device, shield, or filter to prevent clogging of the gas input 605 by the sprayed molten salt 30. The mixture of the molten salt 30 and the gas into a liquid salt 606 (e.g., the molten salt 30) contained within a laundering chamber 608 forms a froth 609 on the surface of the liquid salt 606.

The laundering chamber 608 includes a down-comer 610, having a first end 612 in which the nozzle 604 is positioned above the surface of the liquid salt 606 contained within the laundering chamber 608, and a second end 614 with an opening 616 located beneath the surface of the liquid salt 606. The mixture of the molten salt 30 and the gas are impinged on the surface of the liquid salt 60 in the down-comer 610 thereby producing froth 609 within the down-comer 610. The froth 609 may completely fill the down-comer 610, exit the second opening 616 of the down-comer 610, and rise to the surface of the liquid salt 606 (indicated in by curved arrows in FIG. 5), thereby accumulating on the surface of the liquid salt 606.

The accumulated froth 609 travels to a filtration chamber 620 interconnected to the laundering chamber 608 via a passage 611 (e.g., a tube, a pipe, or a spillway,). The filtration chamber 620 is configured to receive the froth 609 and separate the insoluble fission products and gas fission products from the froth 609. The filtration chamber 620 includes a filter 622 having a first end 626 into which the froth 609 from the laundering chamber 608 is received and a second end 630 the output of which is a molten salt filtrate. Under gravity and/or an induced pressure (e.g., a pressure induced by a suction pump), the froth 609 passes through the filter 622. The filter 622 is configured to collect the one or more insoluble fission products and cause the release of the one of more gas fission products. In this embodiment, the filter 622 is a mesh filter having stainless steel or nickel mesh. The mesh size of the filter 622 decreases from the first end 626 to the second end 630.

The filter 622 is further configured to be replaceable. For example, a lifting loop 623 is affixed to the filter 622 by which filter 622 may be removed from or inserted into the filtration chamber 620. An opening 627 is disposed on the top surface of the filtration chamber 620 through which the filter 622 may be replaced. The replacement of the filter 622 may be performed by a robotic arm or remotely-controlled lifting arm. The filtration chamber 620 further includes O-rings 613 or other contrivances to prevent the froth from bypassing the filter 622.

A first portion 624 of chamber 620 is disposed proximate the first end 626 of the filter 622 and is configured to collect the released gas fission products. The collected gas travels through a demister 625 (a high-surface area flow-through device, e.g., metal mesh or screen, or assembly of packed vanes) configured to further remove the molten salt 30 from the gas, and enters a gas holdup vessel 630 configured to collect the released one or more gas fission products from the filtration chamber 620. The demister 625 may be further configured to allow the collected molten salt 30 to return to the filtration chamber 620 or the laundering chamber 608. The collected gas fission products in the gas holdup vessel 630 are recycled and fed to the laundering chamber 608 where the collected gas fission products are combined with the molten salt 30 received from the molten salt reactor 10 to form the mixture.

The recycle of the gas may be driven by a gas pump 629, and a variable-flow valve 631 is disposed to control the rate of gas flow from the holdup vessel 630. The holdup vessel 630 contains a suitable adsorbent (e.g., carbon) that collects nonradioactive decayed products of the gas fission products. Since gas is cycled in the froth floatation unit 60, radioactive gas fission products decay and their breakdown products are adsorbed in the holdup vessel 630.

A second portion 628 of chamber 620 is disposed proximate the second end 630 of the filter 622, is configured to collect the molten salt filtrate. The froth floatation unit 60 further includes a first return pipe 632 interconnected between the second portion 628 of the filtration chamber 620 and the molten salt reactor 10 to return the molten salt filtrate to the molten salt reactor 10.

Additionally, a second return pipe 607 is disposed to transport at least a portion of the liquid salt 606 (the molten salt 30) from the laundering chamber 608 to the molten salt reactor 10. The second return pipe 607 may be configured to minimize the flow of gas fission products transported by the return pipe 607. For example, the first return pipe 607 is disposed on the bottom surface of the laundering chamber 608, and the diameter of the first return pipe 607 is modified to adjust the flow rate of the molten salt 30 within the first return pipe 607. The transportation within the first and the second return pipes may be driven by gravity or a mechanically induced pressure (e.g., by a pump). In preferred embodiments, during a steady state of operation, the rate of molten salt 30 entering the froth floatation unit 60 equals the rate of molten salt 30 returning to the molten salt reactor 10.

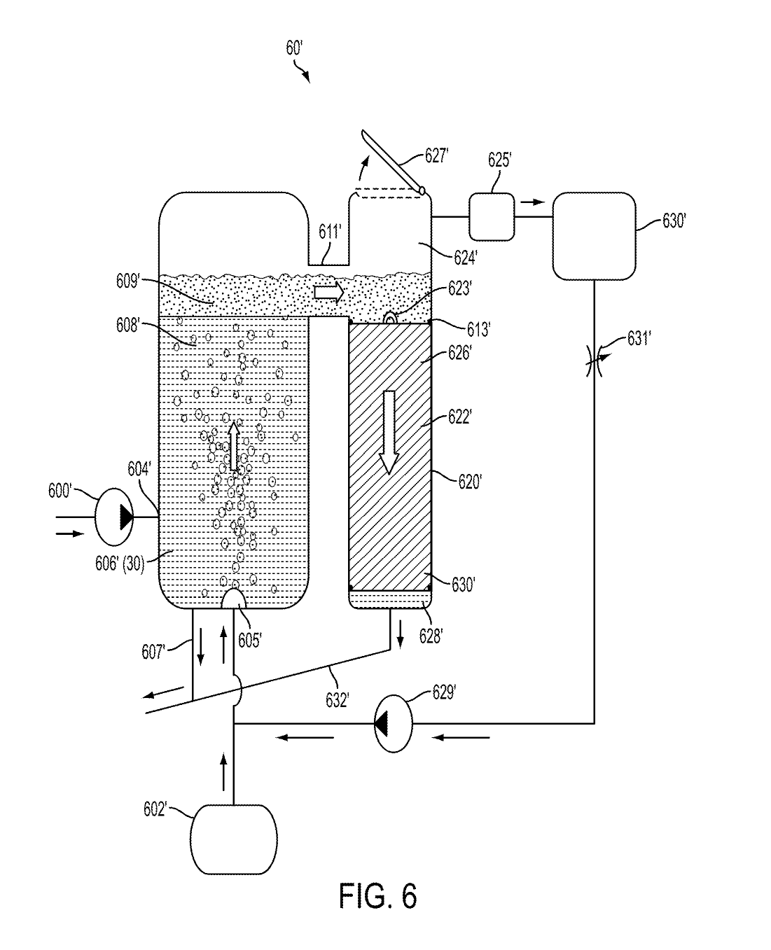

FIG. 6 illustrates another embodiment of the invention. Froth floatation unit 60′, instead of using nozzle 604 and gas input 605 to generate the froth in the down-comer 610, as described with respect to froth floatation unit 60, FIG. 5, generates froth 609′ by creating gas bubbles that travel from the bottom of laundering chamber 608′ to the surface of the molten salt 30 (known as sparging).

In this embodiment, molten fuel salt 30 from the molten salt reactor 10 is pressurized by a pump 600′ and injected into a laundering chamber 608′. The laundering chamber 608′ is partly filled by a liquid salt 606′ (the molten salt 30). A pressurized gas is also introduced into the laundering chamber 608′ through a gas input 605′ disposed on the bottom surface of the laundering chamber 608′. The gas input 605′ may include a valve to prevent contamination by the molten salt 30 during the operation if the gas pressure within the gas input 605′ is sufficient to prevent such contamination.

The gas injected through the gas input 605′ travels from the bottom of laundering chamber 608′to the surface of the molten salt 30. This technique is known as sparging. During the sparging process, at least a portion of the gas fission products (e.g., radioactive noble gases) in the molten salt 30 migrate with the gas, and particles of insoluble fission products (e.g., noble metals) accumulate around gas-liquid interfaces.

As a result, froth 609′ accumulates on the surface of the molten salt 30, containing an elevated concentration of gas fission products and insoluble fission products relative to the molten salt 30.

All other components and functions of froth floatation unit 60′ are the same as those in the froth floatation unit 60 described in FIG. 5.

Although designed with molten salt reactor in mind, the nuclear reactor of the present invention may be another type of reactor, for example, the nuclear reactor may be a graphite-moderated reactor, a water-moderated reactor (e.g., a heavy-water reactor or a light-water-moderated reactor), a light-element-moderated reactor (e.g., a liquid metal cooled reactor), or an organically moderated reactor. In some embodiments, the nuclear reactor may be nuclear fission reactor (e.g, a thermal rector or a fast neutron reactor) or a nuclear fusion reactor. The nuclear reactor may be solid fueled, fluid fueled or gas fueled.

Throughout this document, the terms “molten salt reactor system” denote any system that derives an energy output mostly or entirely from controlled nuclear fission The terms “liquid salt,” “salt” and “molten salt” denote some mixture of molten salt, fissionable fuel material (e.g., thorium, uranium, plutonium), fission products, and possibly other additives or substances that is circulated through the molten salt reactor. The term “molten salt reactor” (MSR) denotes a reactor whose fuel is a liquid at normal operating temperatures and pressures of the system, particularly, the chamber, tank, or vessel within which the molten salt resides during normal energy-producing operation.

Although single-fluid MSRs are generally described herein, other MSRs are contemplated and within the scope of the invention. Also the MSRs generally comprise molten salt, other MSR liquid-fuel media in which fissionable atoms may be suspended, dissolved, or otherwise mixed, and in which fission products may accumulate, are contemplated and within the scope of the invention.

References to filters or other objects or materials as being made of “nickel,” “steel,” and the like substances do not preclude the presence of other alloying substances (e.g., carbon, beryllium) in such objects or materials.

The term “nozzle” denotes any channel, orifice, set of orifices, or other device through which a fluid may be made to flow so as to produce a jet or spray of liquid or foam at the output of the device.

The following are more comprehensive listings of fission products applicable to the present invention. These lists are illustrative and not meant to be exhaustive.

### Fission Products Sufficiently Noble to Maintain a Reduced and Insoluble State in Molten Salt of the Present Invention:

Germanium-72, 73, 74, 76
Arsenic-75
Selenium-77, 78, 79, 80, 82
Yttrium-89
Zirconium-90 to 96
Niobium-95
Molybdenum-95, 97, 98, 100
Technetium-99
Ruthenium-101 to 106
Rhodium-103
Palladium-105 to 110
Silver-109
Cadmium-111 to 116
Indium-115
Tin-117 to 126
Antimony-121, 123, 124, 125
Tellurium-125 to 132
   Fission Products that will Form Gaseous Products at the Operating Temperature of the Present Invention:
Bromine-81
Iodine-127, 129, 131
Xenon-131 to 136
Krypton-83, 84, 85, 86

Fission Products that will Remain in the Salt as Chloride Compounds in Addition to Actinide Chlorides (Th, Pa, U, Np, Pu, Am, Cm) and Carrier Salt Chlorides(Na, K, Ca) in Connection with the Present Invention:
Rubidium-85, 87
Strontium-88, 89, 90
Caesium-133, 134, 135, 137
Barium-138, 139, 140
Lanthanides (lanthanum-139, cerium-140 to 144, praseodymium-141, 143, neodymium-142 to 146, 148, 150, promethium-147, samarium-149, 151, 152, 154, europium-153, 154, 155, 156, Gadolinium-155 to 160, Terbium-159, 161, and Dysprosium-161)

A number of implementations have been described above. Nevertheless, it will be understood that various modifications may be made. Accordingly, other implementations are within the scope of the following claims.

What is claimed is:

1. A molten salt reactor comprising:
a reactor vessel;
a molten salt contained within the reactor vessel and undergoing a nuclear reaction, the molten salt including insoluble metal fission products and dissolved gas fission products produced by the nuclear reaction; and
a separation unit configured to receive the molten salt and remove the insoluble metal fission products and dissolved gas fission products from the molten salt; the separation unit including:
a laundering chamber into which the molten salt is introduced to form a froth containing the insoluble metal fission products and dissolved gas fission products; and
a filtration chamber, interconnected to the laundering chamber, configured to receive the froth from the laundering chamber and separate from the froth the insoluble metal fission products and dissolved gas fission products.

2. The molten salt reactor of claim 1, wherein the laundering chamber includes a mixer to mix the molten salt received from the reactor vessel with a gas and a nozzle to spray the molten salt and gas mixture into a liquid salt contained within the laundering chamber to form the froth on the surface of the liquid salt.

3. The molten salt reactor of claim 2, wherein the filtration chamber includes a filter into which the froth from the laundering chamber is received and the output of which is a molten salt filtrate; the filter collecting the insoluble metal fission products and causing the release of the dissolved gas fission products.

4. The molten salt reactor of claim 3 wherein the filtration chamber includes a first portion proximate a first end of the filter for collecting the dissolved gas fission products and a second portion proximate a second end of the filter for collecting the molten salt filtrate.

5. The molten salt reactor of claim 4 wherein the mesh size of the filter decreases from the first end of the filter to the second end of the filter.

6. The molten salt reactor of claim 4 further including a gas holdup vessel interconnected to the first portion of the filtration chamber to collect the dissolved gas fission products from the filtration chamber; wherein the dissolved gas fission products collected in the gas holdup vessel are provided to the laundering chamber to be combined with the molten salt and gas mixture in the laundering chamber.

7. The molten salt reactor of claim 4 further including a return pipe interconnected between the second portion of the filtration chamber and the reactor vessel to return the molten salt filtrate to the reactor vessel.

8. The molten salt reactor of claim 2, further including a pump to pressurize the molten salt received from the reactor vessel before being introduced to the mixer.

9. The molten salt reactor of claim 2, wherein the laundering chamber includes a down-comer, having a first end wherein the nozzle is positioned above the surface of the liquid salt contained within the laundering chamber, and a second end with an opening located beneath the surface of the liquid; the molten salt and gas mixture impinging on the surface of the liquid salt in the down-comer thereby producing the froth within the down-comer, the froth exiting the second opening of the down-comer rising to the surface of the liquid salt.

10. The molten salt reactor of claim 1, wherein the laundering chamber includes a liquid salt and a device to introduce the molten salt received from the reactor vessel to the liquid salt, the laundering chamber also includes a gas input device to introduce a pressurized gas into the liquid salt proximate a bottom of the laundering chamber, the pressurized gas traveling to a surface of the liquid salt thereby forming the froth on the surface of the liquid salt.

11. A separation unit configured to receive molten salt from a reactor vessel, the molten salt including insoluble metal fission products and dissolved gas fission products, the separation unit comprising:
a laundering chamber into which the molten salt is introduced to form a froth containing the insoluble metal fission products and dissolved gas fission products; and
a filtration chamber, interconnected to the laundering chamber, configured to receive the froth from the laundering chamber and separate from the froth the insoluble metal fission products and dissolved gas fission products.

12. A method for removing fission products from molten salt in a molten salt nuclear reactor; the method comprising:
introducing to a laundering chamber molten salt received from the molten salt nuclear reactor, the molten salt including insoluble metal fission products and dissolved gas fission products; and
forming a froth containing the insoluble metal fission products and dissolved gas fission products in the laundering chamber;
transferring the froth from the laundering chamber to a filtration chamber;
and in the filtration chamber, separating from the froth the insoluble metal fission products and dissolved gas fission products.

13. The method of claim 12, including mixing the molten salt received from the reactor vessel with a gas and spraying the molten salt and gas mixture into a liquid salt contained within the laundering chamber to form the froth on the surface of the liquid salt.

14. The method of claim 13, includes filtering the froth to produce a molten salt filtrate and to cause the release of the dissolved gas fission products.

15. The method of claim 14 wherein the filtration chamber includes a first portion proximate a first end of the filtration chamber for collecting the dissolved gas fission products and a second portion proximate a second end of the filtration chamber for collecting the molten salt filtrate.

16. The method of claim 15 further including collecting in a holdup vessel the dissolved gas fission products from the first end of the filtration chamber; combining the collected dissolved gas fission products with the molten salt and gas mixture in the laundering chamber.

17. The method of claim 15, further including returning the molten salt filtrate to the reactor vessel.

18. The method of claim 13, further including pressurizing the molten salt received from the reactor vessel before the step of introducing the molten salt to the laundering chamber.

19. The method of claim 13, further including providing in the laundering chamber a down-comer, having a first end above the surface of the liquid salt contained within the laundering chamber, and a second end with an opening located beneath the surface of the liquid; and including impinging the molten salt and gas mixture on the surface of the liquid salt in the down-comer thereby producing the froth within the down-comer; the froth exiting the second opening of the down-comer and rising to the surface of the liquid salt.

20. The method of claim 12, including introducing the molten salt received from the reactor vessel to a liquid salt in the laundering chamber and introducing a pressurized gas into the liquid salt proximate a bottom of the laundering chamber; wherein the pressurized gas travels to a surface of the liquid salt thereby forming the froth on a surface of the liquid salt.
